(19) United States
(12) Patent Application Publication
(10) Pub. No.: US 2023/0268675 A1
(43) Pub. Date: Aug. 24, 2023

(54) CONNECTOR ASSEMBLY

(71) Applicant: Jaguar Land Rover Limited, Coventry, Warwickshire (GB)

(72) Inventors: Inaki BARROSO, Coventry (GB); Panu YLIHAAVISTO, Coventry (GB); Stephen HICKEY, Coventry (GB)

(21) Appl. No.: 18/004,157

(22) PCT Filed: Jul. 5, 2021
(86) PCT No.: PCT/EP2021/068478

§ 371 Date: Jan. 3, 2023

(30) Foreign Application Priority Data
Jul. 3, 2020 (GB) 2010198.6

(51) Int. Cl. H01R 4/64; B60R 16/02; H01R 11/12; H01R 4/34; H01R 43/00

(52) U.S. Cl. CPC H01R 4/646; B60R 16/02; H01R 11/12; H01R 4/34; H01R 43/005; H01R 2201/26

(57) ABSTRACT

A connector assembly for electrically connecting a vehicle electrical system to a vehicle ground plane includes: a housing having a first aperture arranged to receive a stud, an electrical connector disposed within the housing and arranged to be electrically connected to the stud, and a radial seal disposed around a periphery of the first aperture, the radial seal being arranged to provide a seal between the stud and the housing.

### TECHNICAL FIELD

The present disclosure relates generally to a connector assembly and in particular, but not exclusively to a connector assembly for electrically connecting a vehicle electrical system to a vehicle ground plane. Aspects of the invention relate to a connector assembly, to a system, to a method and to a vehicle.

### BACKGROUND

In electric, internal combustion or hybrid vehicles it is known to connect electrical components to the body in white (BIW) for ground connections. A stud formed of an electrically conductive material is affixed to the BIW, and a connector is connected to the stud and secured with a weld, rivet or nut. The cable connected to the connector may be sealed with heat shrink tubing. This method leaves the majority of the connection sealed, but the connector itself is still exposed which may under some circumstances reduce the lifetime of the connection through galvanic corrosion of the connection. This occurs at the junction between two different metals, and is more severe when high voltages are transmitted across the junction. Accordingly, such corrosion can be more severe for high-voltage (e.g. 400V) applications.

It is an object of embodiments of the invention to at least mitigate one or more of the problems of the prior art.

### SUMMARY OF THE INVENTION

An aspect of the present invention comprises a connector assembly for electrically connecting a vehicle electrical system to a vehicle ground plane, the connector assembly comprising: a housing having a first aperture arranged to receive a stud, an electrical connector disposed within the housing and arranged to be electrically connected to the stud, and a radial seal disposed around a periphery of the first aperture, the radial seal being arranged to provide a seal between the stud and the housing.

Including a housing comprising an aperture arranged to receive a stud, wherein a radial seal is provided around a periphery of the aperture, provides the means for an operative to quickly and easily create a sealed electrical connection which is resistant to ingress of contaminants and moisture. The disclosed connector assembly allows an operative to quickly and safely place the components together thus speeding up the manufacturing process and providing a sealed connection. The connector assembly may be particularly well-suited to providing connections between a high-voltage circuit and an electrical ground defined by a vehicle BIW, although it will be appreciated that the connector assembly is also useful in making other electrical connections.

In an embodiment, the electrical connector is an eyelet connector.

Using an eyelet connector as the electrical connector allows the operative to slide the housing over the stud, being assured that since the components fit together correctly an electrical contact will be formed between the eyelet connector and the stud. It will be noticeable, both haptically and visually if the connection has not been made properly.

In an embodiment, the connector assembly further comprises an axial seal disposed around the first aperture, wherein the axial seal is arranged to be compressed against a surface of the vehicle ground plane.

Providing an axial seal increases the efficacy of the overall seal of the connector assembly, as it provides a level of redundancy in the sealing arrangement. Furthermore, such an axial seal surrounds the contact area between the stud and the body in white, thereby reducing the risk of galvanic corrosion due to different metals being in contact. The action of attaching the stud to the body in white with the axial seal acting as a buffer which is compressed ensures that the axial seal will be a tight seal. Furthermore, such a seal will prevent a build-up of moisture contacting the base of the stud.

In an embodiment, the housing further comprises a second aperture arranged to receive a sheathed wire, and a second seal arranged to provide a seal between the sheathed wire and the second aperture.

The second seal may be either of a radial seal or axial seal, or a combination of radial seals and axial seals. Providing a second aperture allows an operative to connect the components of an electrical connection within the sealed atmosphere of the housing.

In an embodiment, the housing may be formed of a first housing part and a second housing part, wherein the first aperture is provided on the first housing part, and the second aperture is formed on the second housing part. Optionally, a sheathed cable may be passed through the second aperture prior to connection of the first and second housing parts.

In an embodiment, the connector assembly further comprises an additional electrical connector accessible from outside the housing, the additional electrical connector being in electrical communication with the electrical connector.

Including an additional electrical connector allows a corresponding connector to be connected to the additional electrical connector. In this way a circuit can be connected to the BIW by connecting an end connector of the circuit to the additional electrical connector. Accordingly, a connector assembly according to this embodiment may act as a sealed adaptor between the stud and the end connector of the circuit to be connected to electrical ground via the stud.

In an embodiment, the housing further comprises a third aperture, and a cover arranged to close and seal the third aperture, wherein a fixing to secure the electrical connector to the stud may be inserted into the housing and secured to the stud via the third aperture.

Providing a third aperture through which an operative can attach a fixing to the electrical connector provides a means by which, during vehicle manufacture, the electrical connector can be releasably attached to the stud. It will be understood by the skilled person that the electrical connector could be placed in position with the first radial seal holding the connector assembly in position. Preferably, a fixing will be used to make the connection more secure. Furthermore, in embodiments in which an axial seal is provided, the attachment of the fixing may compress the axial seal against a substrate of the vehicle BIW. Optionally, the fixing is a nut.

In an embodiment, the third aperture is opposite the first aperture.

In an embodiment, the first aperture has a first diameter and the eyelet connector comprises an eyelet having a second diameter, wherein the first diameter is greater than the second diameter,

whereby the connector assembly is electrically connectable to a stud having a base portion and an upper portion, the base portion having a diameter greater than the upper portion.

This arrangement of features allows an operative to slide the housing over the stud and the eyelet connector over the stud simultaneously such that the stud and the eyelet are in electrical contact when the stud is fully inserted into housing.

In an embodiment, the radial seal is arranged to be compressed against a surface of the stud when the stud is received within the first aperture.

Having the radial seal compressed against the surface of the stud means that when the housing is in position about the stud, there is no air gap or pocket between the housing and the stud meaning that the seal is airtight and resistant to ingress of moisture or contaminants.

In an embodiment, the cover comprises a feature arranged to secure the cover in a closed position relative to the housing. For example, the feature may comprise a latch that may only be closed when the cover is in its closed position.

In an embodiment, a seal is formed between the cover and the housing when the cover is in the closed position.

A further aspect of the present invention comprises a connection system comprising a connector assembly as described above and further comprising the stud as described above.

In an embodiment, the connection system further comprises the fixing as described above.

In an embodiment, the stud comprises a threaded portion, and the fixing comprises a nut.

A further aspect of the present invention comprises a vehicle comprising a connection system as described above.

In an embodiment, the stud is connected to the vehicle substrate, also referred to as the vehicle body in white (BIW). In other embodiments, the stud may be connected to a component that does not form part of the BIW, but which is electrically and mechanically connected to the BIW.

In an embodiment, the connection system provides a ground connection for a circuit of the vehicle, preferably for a high-voltage circuit of the vehicle.

A further aspect of the present invention provides a method of electrically connecting a vehicle electrical system to a vehicle ground plane comprising connecting an electrical connection assembly of the vehicle electrical system to a stud on the vehicle ground plane, wherein the electrical connection assembly comprises: a housing having a first aperture, an electrical connector disposed within the housing, and a radial seal disposed around a periphery of the first aperture wherein the method comprises: placing the stud within the housing via the first aperture; and securing the electrical connector to the stud, wherein the step of securing the electrical connector to the stud causes the radial seal to compress against the stud.

In an embodiment, the step of securing the electrical connector to the stud comprises placing an eyelet connector onto the stud, and subsequently applying a fixing to secure the eyelet connector to the stud.

In an embodiment, the fixing comprises a nut, and wherein the stud comprises a threaded portion arranged to receive the nut.

Although the present invention has particular applications in providing a connection to an electrical ground defined by a vehicle BIW for a high-voltage circuit, it will be understood that it is equally applicable to providing such a connection for low-voltage circuits, or for providing other electrical connections. Within the context of the present invention, the term “high-voltage” should be taken to encompass any circuit that may be used to power a vehicle traction motor. For example, a circuit having a voltage of about 48V or higher may be considered to be a “high-voltage” circuit within the context of the present application. However, circuits having a voltage of less than 48V will generally not be considered “high-voltage” within the context of the present application. As such, the term “high-voltage” may be taken to mean 48V DC or higher, and an equivalent RMS level for AC connections. Accordingly, a 12V circuit used to power a starter motor and electronic systems within a vehicle would be considered to be low-voltage within the context of the present application.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

Embodiments of the invention will now be described by way of example only, with reference to the accompanying figures, in which:

FIG. 1 shows a stud for making electrical connections to a vehicle ground plane in an embodiment of the present invention;

FIG. 2 shows a stud assembly a connector assembly in an embodiment of the present invention connected thereto;

FIG. 3 shows a cross-section through the stud assembly and sealed eyelet connector shown in FIG. 2;

FIG. 4 shows another view of the connector assembly shown in FIGS. 2 and 3;

FIG. 5 shows a view of the connector assembly shown in FIGS. 2-4, in a condition in which the fixing nut is exposed;

FIG. 6 shows a flowchart of a method for electrically connecting a vehicle electrical system to a vehicle ground plane in an embodiment of the present invention; and

FIG. 7 shows a vehicle in an embodiment of the present invention.

### DETAILED DESCRIPTION

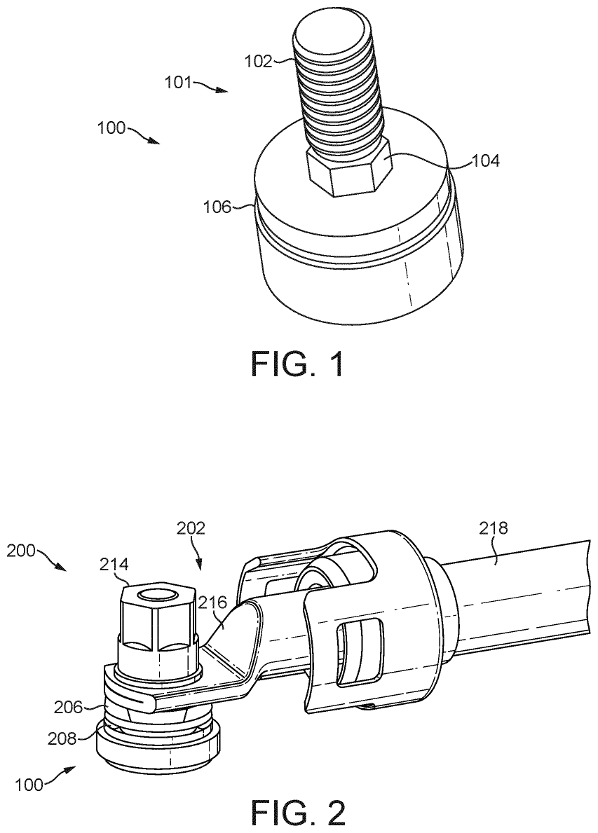

FIG. 1 shows a stud assembly 100 that may be attached to the body in white (BIW) of a vehicle, for example by welding or riveting. The stud 100 is arranged to facilitate electrical connection of an eyelet connector to the BIW, which serves as the electrical ground for the electrical circuits on the vehicle.

As will be well understood by the skilled person, the BIW, which may also be referred to as the vehicle substrate or the vehicle frame, is a metal structure including components that are common to all vehicles within a specific vehicle line, and onto which other components may be joined during the vehicle manufacturing process. As such, it will be understood that the term “body in white” does not imply that the structure is a particular colour. Although the term “body in white” also refers to a stage in the process of manufacturing a vehicle, it will be understood that the components that were present at that stage may also be referred to collectively as “the body in white”. Furthermore, it will be understood that BIW can provide a common grounding point for all electrical systems within a vehicle. The components of the BIW can be made from various different metallic materials, including but not limited to steel, aluminium and magnesium. Accordingly, the connector assemblies of the present invention can be made from materials adapted to interface with a specific body material, or may be selected to be suitable for use with any material that may be present on the BIW.

The stud 100 comprises an upper fastening portion 101, and a base portion 106. In the embodiment shown the fastening portion 101 comprises a threaded portion 102 and a shank portion 104. The threaded portion 102 is constructed for the attachment of a nut to hold an eyelet connector in place on the contact portion 104. The entire stud 100 is formed of an electrically conductive material such that it is able to form a strong electrical connection between an eyelet connector disposed on the connection portion and a vehicle BIW to which the stud is electrically and mechanically connected.

The stud 100 shown in FIG. 1 provides a convenient location for making electrical connections between a vehicle circuit and the vehicle BIW. However, if the connection is not sealed, there is a risk that the connection will be weakened by galvanic corrosion and ultimately require replacement, especially if the stud is used to connect a high-voltage circuit to the vehicle BIW. The stud 100 therefore has a base portion 106 having a larger diameter than the fastening portion, so as to facilitate sealing between the stud and the connector assembly, as will be described in more detail below.

FIG. 2 shows a connection system 200 comprising an exposed stud assembly 100, which is similar to the stud assembly 100 shown in FIG. 1, a connector assembly 202 and a sheathed wire 218, which is electrically and mechanically connected to the connector assembly 202.

The connector assembly 202 comprises an eyelet connector 216 which fits over the fastening portion 101 of the stud assembly 100 and abuts the top of the base portion 106. When the eyelet connector is in position, a nut 214 may be attached to the threaded portion 102 to affix the eyelet connector to the stud 100 such that it cannot be removed without the use of tools, thereby forming a strong electrical contact between the sheathed wire 218 and the stud assembly 100. The stud assembly will typically be electrically and mechanically connected to a component of the BIW, for example by welding or riveting.

The eyelet connector 216 comprises an eyelet constructed to fit around the connection portion of the stud assembly and have a radius substantially equal to or slightly greater than that of the fastening portion 101. The eyelet connector further comprises a connection portion between the eyelet and the sheathed wire 218, which is formed of an electrically conductive material and is electrically connected to the sheathed wire 218.

The eyelet connector will typically be formed from a metal, preferably a copper alloy having a suitable coating, although other electrically conductive materials such as aluminium or steel would also be suitable.

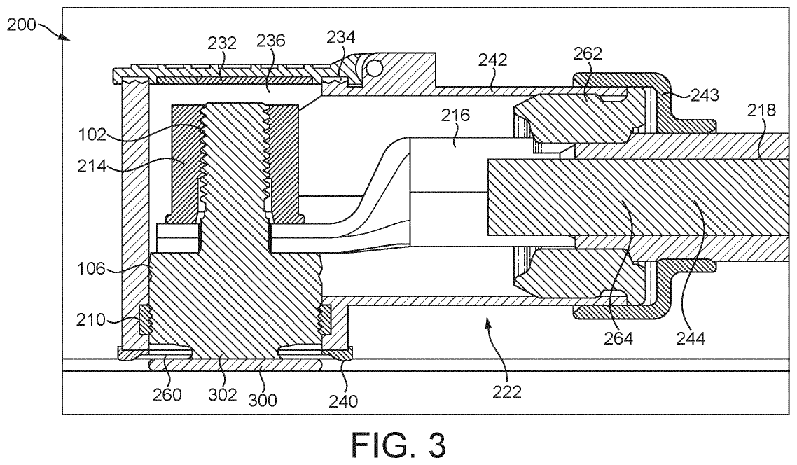

The connector assembly 202 shown in FIG. 2 also comprises a housing enclosing the stud and the other components of the connector assembly, as can be seen from FIGS. 3-5. The housing has been omitted from FIG. 2 for ease of illustration.

FIG. 3 shows a cross-section through the connector assembly 200 shown in FIG. 2, with the housing 222 visible. As shown in FIG. 3, the stud 100 is connected to a substrate 300, which forms part of a vehicle BIW, by a weld 302.

The housing 222 comprises a first part 242 having a first aperture 260, second aperture 264, third aperture 236, and a second part 243 arranged to cover the second aperture 264 and to receive the sheathed wire 218 via a fourth aperture 244.

The first aperture 260 is sized to accept the base portion 106 of the stud 100, such that the diameter of the first aperture is similar to the diameter of the base portion of the stud assembly. A radial seal 210 is provided around an inner periphery of the first aperture. The radial seal 210 may be accommodated by the housing in a groove constructed to line up with the base portion 106, and when the stud 100 is inserted into the first aperture 260 the radial seal engages the cylindrical face of the stud, thereby sealing the first aperture 260.

An axial seal 240 is located on a bottom end surface of the housing 240 and surrounds the opening of the first aperture 260. Accordingly, when the connector assembly 202 is connected to the stud 100, the axial seal 240 is compressed against the surface 300, thereby providing an additional seal around the first aperture 260.

During fitting, the eyelet connector is mechanically and electrically connected to the stud 100 by a nut 214. Because the position of the eyelet connector within the housing is substantially fixed, this urges the housing 222 towards the substrate 300. The axial seal will be therefore compressed against the substrate 300, forming a watertight seal.

The axial seal 240 provides an additional layer of protection such that if the radial seal becomes tarnished of breaks the axial seal will still present a barrier to water and the contaminants.

The radial seal 210 may be provided with castellations that contact the base portion 106 of the stud. Such castellations will provide a plurality of separate annular seals, thereby providing additional protection against contaminants moving towards the eyelet connector from the outside of the housing.

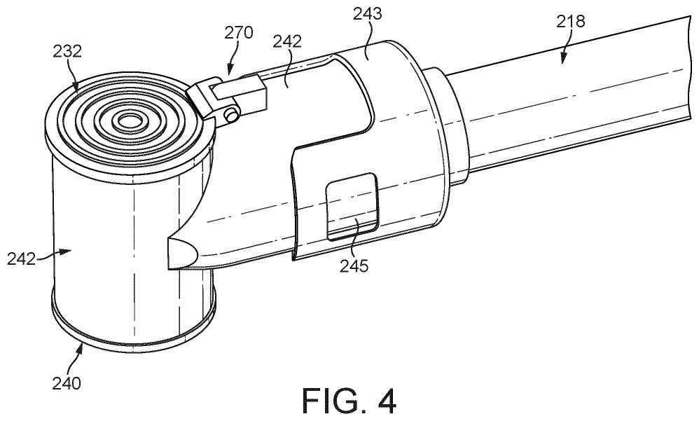

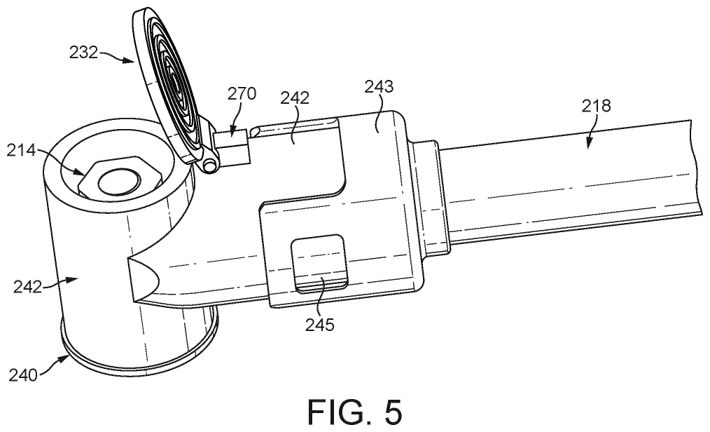

The first part of the housing 242 further comprises a second aperture 264, which is closed by the second housing part 243. The second housing part 243 comprises a fourth aperture 244, through which the sheathed wire 218 is inserted. The second housing part may clip onto the first housing part as best shown in FIGS. 4 and 5, so as to cover the second aperture 264 and allow the sheathed wire to enter the housing. A radial sealing block 262 is provided around the end portion of the sheathed wire 218 and the eyelet connection. When the sheathed wire is received within the housing 222, the radial sealing block is urged against the inner surface of the first housing component 242. This forms a seal which prevents water and other contaminants reaching the connector from outside of the housing via the second aperture 264. The radial sealing block 262 also serves to fix the position of the eyelet connector within the housing 222.

In an alternative embodiment the second aperture 264 may be sealed by an axial seal which is compressed between the first and second housing components when the second housing component 243 is connected to the first housing component.

The housing 222 shown in FIG. 3 further comprises a third aperture 236. The purpose of this aperture is to allow an operative to attach or remove the fixing nut 214 from the stud assembly. The third aperture 236 is be closed using a cover 232 disposed opposite the first aperture. When the cover is closed it is sealed by an axial seal 234 which is compressed by the closing of said cover. The cover 232 and/or the first housing part 242 may be provided with a feature to hold the cover in its closed position. For example, a latch may be provided that can only be closed once the cover is in its closed position. Advantageously, this holds the cover in its closed position, and also provides a clear visual indication that the cover has been properly closed for manufacturing and/or service operatives.

FIG. 4 shows the housing 222 in closed configuration. It can be seen that no portion of the electrical circuitry is exposed when the components are in place.

The cover 232 may be formed of the same material as the housing or it may be formed of rubber or any other suitable material. The cover may be flexible or formed of a hard plastic attached to a hinge 270 such that it cannot be lost when removed. The cover may close as a snap fit. In some embodiments a spring means (not shown) may be provided at the hinge 270, so as to bias the cover 232 into the closed position shown in FIG. 4.

The axial seal 240 is visible from the exterior and provides a seal which prevents contaminants from reaching the electrical components within the housing.

FIG. 5 shows the housing 222 with the cover 232 in an open configuration. The fixing 214 is therefore exposed such that an operative can access it, allowing them to either release or tighten the connection between the eyelet connector and the stud 100. When the eyelet connector is released the housing can be pulled away from the stud assembly. The stud assembly is held in place on the BIW any suitable means, for example by welding or riveting.

The connection between the first and second housing parts 242, 243 may be made by any suitable means. For example, respective barbed connectors (not shown) on the first housing part 242 may engage each of the holes 245 on the second housing part to hold the second housing part in place, or a suitable adhesive may be used to connect the first and second housing parts.

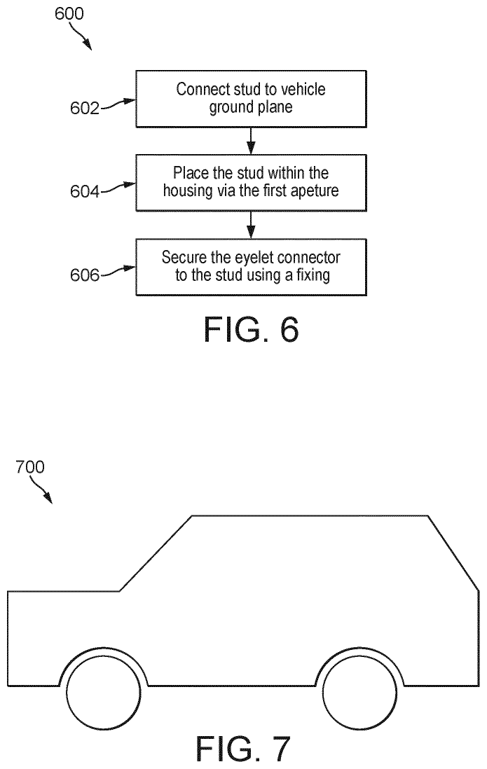

FIG. 6 shows a method 600 of electrically connecting a vehicle electrical system to a vehicle ground plane in an embodiment of the present invention. The first step 602 of the method comprises connecting a stud to the vehicle ground plane. The stud may be a stud 100 as shown in FIG. 1, and may be connected by any suitable method, such as welding or riveting. In the next step 604 the stud is placed within the housing via the first aperture, such that the eyelet connector (which is within the housing) is placed onto the stud. Typically, the aperture in the eyelet connector is substantially concentric with the first aperture, such that the action of placing the stud within the housing causes the eyelet connector to be placed onto the stud. The final step 606 comprises securing the eyelet connector to the stud using a fixing, in some embodiments the fixing is a nut. In embodiments where the fixing is a nut, the method may further comprise closing a cover to seal the aperture via which the nut was accessed, and optionally securing the cover in the closed position.

FIG. 7 shows a vehicle 700 part of the manufacture of which may involve the method shown in FIG. 7. The vehicle 700 may comprise one more of the connector assemblies and/or the connection systems as described above. In particular, the vehicle may be a hybrid or electric vehicle having a high-voltage circuit arranged to power one or more traction motors, and the high-voltage circuit may be connected to electrical ground via the connector assembly and/or connection system.

Although the embodiments described above show a sheathed wire connected to the eyelet connector, it will be understood that other components could be connected in alternative embodiments. For example, the eyelet connector could be connected to a pin in a plug or socket defined on the outer surface of the housing, such that a connection of an external circuit to the stud could be effected by connecting a corresponding socket or plug to the connector.

Furthermore, although radial seal is provided as a part of the connector assembly in the embodiments described above, in other embodiments the radial seal may be disposed on the stud before the housing is placed over the stud.

As used herein the term “body in white” is explicitly intended to be interchangeable with the term vehicle ground plane, automobile frame, frame structure. It will be understood that the term “body in white” does not imply that the structure is a particular colour.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed. The claims should not be construed to cover merely the foregoing embodiments, but also any embodiments which fall within the scope of the claims.

1. A connector assembly for electrically connecting a vehicle electrical system to a vehicle ground plane, the connector assembly comprising:
a housing having a first aperture arranged to receive a stud;
an electrical connector disposed within the housing and arranged to be electrically connected to the stud; and
a radial seal disposed around a periphery of the first aperture, the radial seal being arranged to provide a seal between the stud and the housing.

2. The connector assembly as claimed in claim 1, wherein the electrical connector is an eyelet connector.

3. The connector assembly as claimed in claim 1, wherein the connector assembly further comprises an axial seal disposed around the first aperture, wherein the axial seal is arranged to be compressed against a surface of the vehicle ground plane.

4. The connector assembly as claimed in claim 1, wherein the housing further comprises a second aperture arranged to receive a sheathed wire, and a second seal arranged to provide a seal between the sheathed wire and the second aperture.

5. The connector assembly as claimed in claim 1, further comprising an additional electrical connector accessible from outside the housing, the additional electrical connector being in electrical communication with the electrical connector.

6. The connector assembly as claimed in claim 1, wherein the housing further comprises a third aperture, and a cover arranged to close and seal the third aperture.

7. The connector assembly as claimed in claim 6, wherein the third aperture is opposite the first aperture.

8. The connector assembly as claimed in claim 2, wherein the first aperture has a first diameter and the eyelet connector comprises an eyelet having a second diameter, wherein the first diameter is greater than the second diameter,
whereby the connector assembly is electrically connectable to a stud having a base portion and an upper portion, the base portion having a diameter greater than the upper portion.

9. The connector assembly as claimed in claim 1 wherein the radial seal is arranged to be compressed against a surface of the stud when the stud is received within the first aperture.

10. The connector assembly as claimed in claim 6, and further comprising a feature arranged to secure the cover in a closed position relative to the housing.

11. The connector assembly as claimed in claim 10, wherein a seal is formed between the cover and the housing when the cover is in the closed position.

12. A connection system comprising the connector assembly as claimed in claim 1 and further comprising the stud.

13. A vehicle comprising the connection system as claimed in claim 12.

14. A method of electrically connecting a vehicle electrical system to a vehicle ground plane comprising connecting an electrical connection assembly of the vehicle electrical system to a stud on the vehicle ground plane, wherein the electrical connection assembly comprises:
a housing having a first aperture,
an electrical connector disposed within the housing, and
a radial seal disposed around a periphery of the first aperture,
wherein the method comprises:
placing the stud within the housing via the first aperture; and
securing the electrical connector to the stud,
wherein securing the electrical connector to the stud causes the radial seal to compress against the stud.

15. The connector assembly as claimed in claim 6, wherein a fixing to secure the electrical connector to the stud is inserted into the housing and secured to the stud via the third aperture.
